(19) United States
(12) Patent Application Publication
(10) Pub. No.: US 2023/0339028 A1
(43) Pub. Date: Oct. 26, 2023

(54) CHIP BREAKING STRUCTURE OF MINI CUTTING BIT

(71) Applicant: HAO JUEN TECHNOLOGY CO., LTD., Taichung (TW)

(72) Inventors: SHINN LIANG CHANG, Yunlin County (TW); TZU CHI CHAN, Yunlin County (TW); MENG HUA LI, Yunlin County (TW); I HUNG WANG, Taichung (TW)

(21) Appl. No.: 18/193,416

(22) Filed: Mar. 30, 2023

(30) Foreign Application Priority Data
Apr. 26, 2022 (TW) 111204274

(51) Int. Cl. B23B 51/00

(52) U.S. Cl. CPC B23B 51/011; B23B 2251/48

(57) ABSTRACT

A mini cutting bit includes a shank and a cutting part. The cutting part has a first spiral portion and a second spiral portion parallelly and twistedly formed thereon. The cutting part further has two chip removal flutes between the first and the second spiral portions. The first spiral portion has a first chip breaking flute on a top thereof while the second spiral portion has a second chip breaking flute. Widths of the first and the second chip breaking flutes are smaller than that of the tops of the first and the second spiral portions respectively.

### BACKGROUND OF THE INVENTION

### 1. Technical Field

The present invention relates to a cutter of a machine tool, and more particularly to a mini cutting bit, which may increase chip removing and breaking capacity.

### 2. Description of Related Art

In present days, a variety of workpieces to be processed, and more and more small workpieces to be processed, so that how to process small workpieces is an important issue. However, conventional cutting bits are large to cut workpieces in a low speed, and the large cutters are not appliable to a complex task. Now a day, the cutting tasks are virous and sizes of workpiece is getting small, so the cutters must change to meeting the modern tasks. Therefore, people reconsidered to provide cutting bits with a small size to enhance cutting performance. As a result, mini cutting bits are provided in the market.

Conventional mini cutting bits includes millers and drills with a diameter less than 6.35 mm Such mini cutting bits are important to the complex and fine cutting task in high spindle speed. The smaller the diameter of the cutting bit is, the higher the spindle speed is needed, however, the conventional machine tool is unable to reach such high speed. The mini cutting bit has a high risk of damage in low speed cutting task, 10,000 rpm or less, because of high brittleness of the mini cutting bit.

Poor chip removal is another reason that causes the mini cutting bits damaged. In practices, the mini cutting bits are damaged by poor chip removal more than by improper cutting parameters. Compared to a large cutting bit, the mini cutting bits are lighter and brittle. So, how to strengthen the mini cutting bits is an important issue to the manufacturers.

### BRIEF SUMMARY OF THE INVENTION

In view of the above, the primary objective of the present invention is to provide a mini cutting bit, which has a great capacity of chip removal to reduce the risk of damaging the mini cutting bit.

In order to achieve the objective of the present invention, a mini cutting bit includes a shank and a cutting part connected to an end of the shank. The cutting part has a first spiral portion, a first chip removal flute and a first chip breaking flute. The first chip removal flute is parallel to the first spiral portion. The first chip breaking flute is formed on a top of the first spiral portion, and a width of the first chip breaking flute is smaller than that of the top of the first spiral portion.

In an embodiment, the cutting part further has a second spiral portion, a second chip removal flute and a second chip breaking flute; the second spiral portion is parallel to the first spiral portion; the first and the second chip removal flutes are formed between the first and the second spiral portions respectively; the second chip breaking flute is formed on a top of the second spiral portion, and a width of the second chip breaking flute is smaller than that of the top of the second spiral portion.

In an embodiment, the cutting part has a first end and a second end; the second end is connected to the shank, and the first end is opposite to the second end and is a free end; the first chip breaking flute extends between the first end and the second end.

In an embodiment, the first chip breaking flute has two side edges, and the top of the first spiral portion has two side edges; the side edges of the top of the first spiral portion are kept a first distance from the side edges of the first chip breaking flute.

In an embodiment, the cutting part has a first end and a second end; the second end is connected to the shank, and the first end is opposite to the second end and is a free end; the second chip breaking flute extends between the first end and the second end.

In an embodiment, the second chip breaking flute has two side edges, and the top of the second spiral portion has two side edges; the side edges of the top of the second spiral portion are kept a second distance from the side edges of the second chip breaking flute.

In an embodiment, the first chip breaking flute is a V-shaped flute or a U-shaped flute.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is an enlarged view of the first preferred embodiment of the present invention, showing the first end of the cutting part;

FIG. 3 is an enlarged view of the first preferred embodiment of the present invention, showing the second end of the cutting part;

FIG. 4 is a sectional view along the 4-4 line in FIG. 1 of the first preferred embodiment of the present invention;

FIG. 5 is a sectional view of the cutting part of a second preferred embodiment of the present invention; and

FIG. 6 is a sketch diagram of the first preferred embodiment of the present invention, showing how the mini cutting bit work.

### DETAILED DESCRIPTION OF THE INVENTION

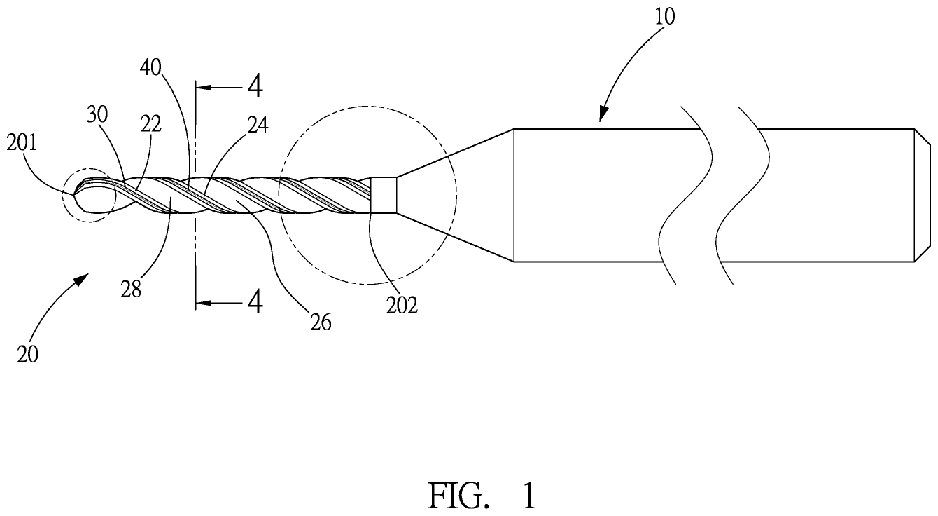

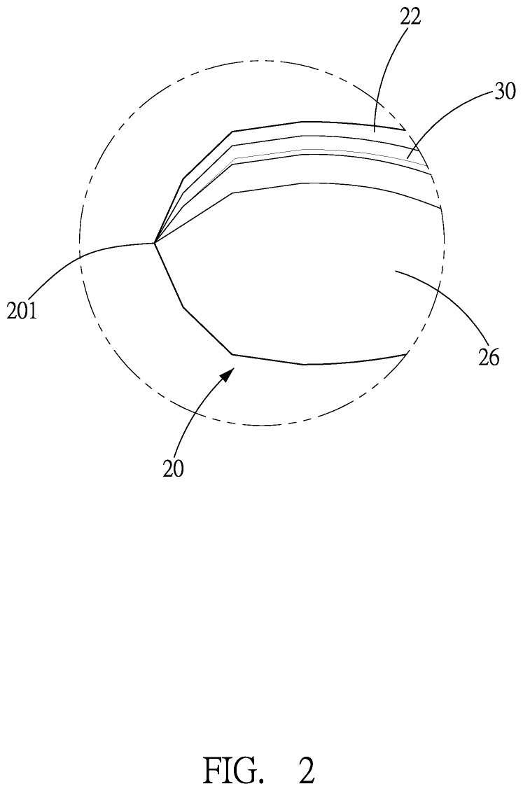

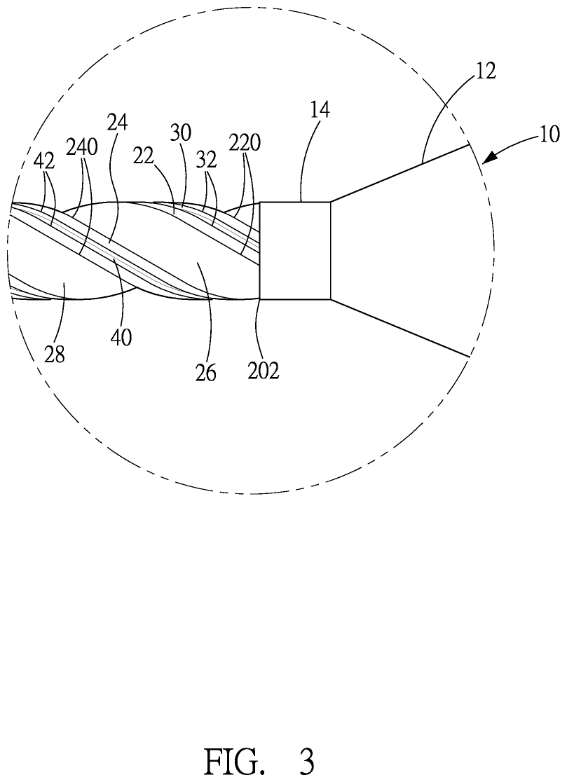

As shown from FIG. 1 to FIG. 4, a mini cutting bit of the first preferred embodiment of the present invention includes a shank 10 and a cutting part 20. The cutting part 20 has a first chip breaking flute 30 and a second chip breaking flute 40.

The shank 10 is a round shaft having an end connected to the cutting part 20. The shank 10 has a conical portion 12 and a pillar portion 14 adjacent to the cutting part 20. The pillar portion 14 has opposite ends connected to the cutting part 20 and the conical portion 12 to increase a strength of the connection of the shank 10 and the cutting part 20. A diameter of the pillar portion 14 is substantially identical to that of the cutting part 20, and a diameter of the conical portion 12 gradually increases from an end connected to the pillar portion 14.

The cutting part 20 has a spiral structure with an end connected to the pillar portion 14. A diameter of the cutting part 20 is smaller than that of the shank 10. The cutting part 20 has a first end 201 and a second end 202. The second end 202 is connected to the pillar portion 14 of the shank 10, and the first end 201 is opposite to the second end and is a free end. The cutting part 20 has a first spiral portion 22 and a second spiral portion 24 parallelly and twistedly formed thereon between the first end 201 and the second end 202. The first and the second spiral portions 22 and 24 are capable of cutting a workpiece. The cutting part 20 further has a first chip removal flute 26 and a second chip removal flute 28 between the first and the second spiral portions 22 and 24 respectively. The first and the second chip removal flutes 26 and 28 are parallelly and twistedly formed on the cutting part 20 between the first and the second spiral portions 22 and 24 respectively. The first and the second chip removal flutes 26 and 28 are designed to eject chips in the cutting task.

The first chip breaking flute 30 is provided on a top of the first spiral portion 22. The first chip breaking flute 30 extends between the first end 201 and the second end 202 in a spiral form, which is identical to the first spiral portion 22. A width of the first chip breaking flute 30 is smaller than that of the top of the first spiral portion 22. The first chip breaking flute 30 has two side edges 32, which are kept a first distance from side edges 220 of the top of the first spiral portion 22.

The second chip breaking flute 40 is provided on a top of the second spiral portion 24. The second chip breaking flute 40 extends between the second end 201 and the second end 202 in a spiral form, which is identical to the second spiral portion 24. A width of the second chip breaking flute 40 is smaller than that of the top of the second spiral portion 24. The second chip breaking flute 40 has two side edges 42, which are kept a second distance from side edges 240 of the top of the second spiral portion 24.

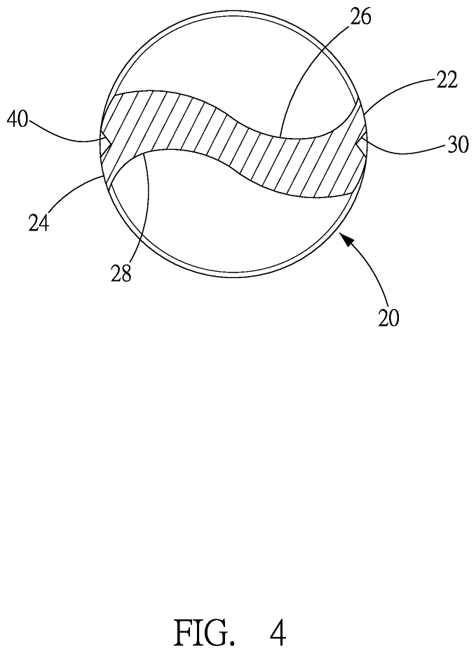

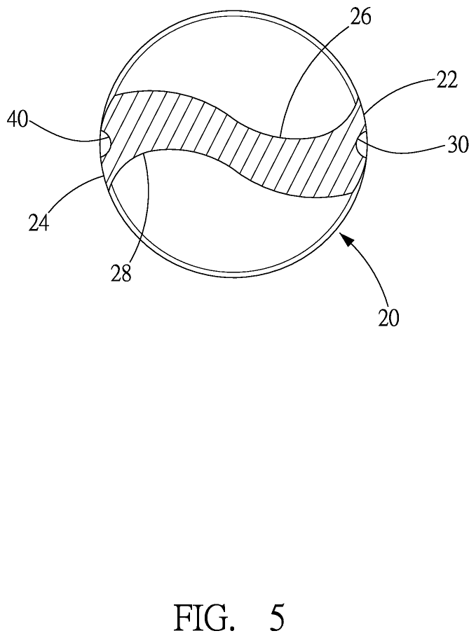

As shown in FIG. 4, the first and the second chip breaking flutes 30 and 40 are V-shaped flutes in the first preferred embodiment, and they are U-shaped flutes in the second preferred embodiment as shown in FIG. 5. In another embodiment, the first and the second chip breaking flutes 30 and 40 may be any shapes.

Above description is the structure of the mini cutting bit of the present embodiment, and how the mini cutting bit work is described hereafter.

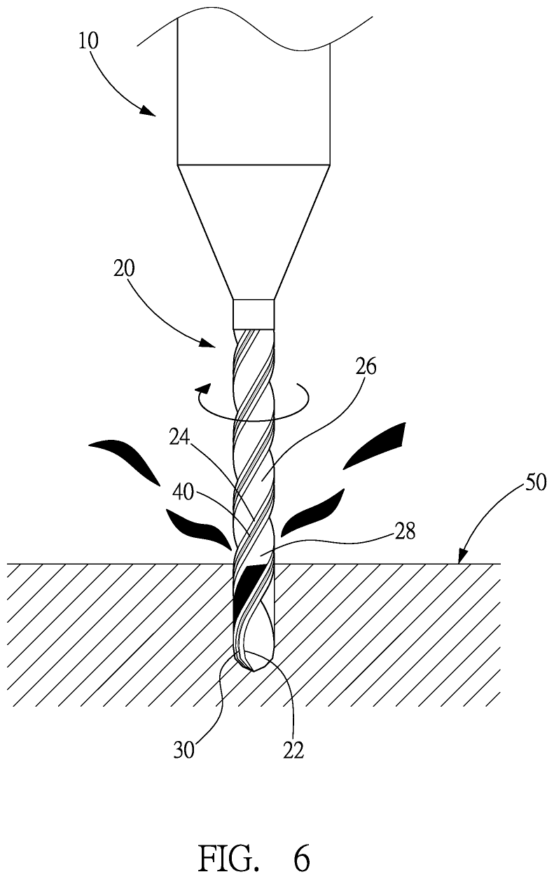

As shown in FIG. 6, the shank 10 is connected to a spindle (not shown) of a machine tool to be driven to turn the mini cutting bit, so that the cutting part 20 may cut a workpiece 50. Chip generated in the cutting task will be ejected via the first and the second chip removal flutes 26 and 28. Compared to the conventional mini cutting bit without the chip breaking flute, the chip is much easier to be ejected because the chip will be cut into small pieces and short lengths which may reduce the risk of the chip jammed in the first and the second chip removal flutes 26 and 28. As a result, the mini cutting bit of the present embodiment has a low risk of damage by the chip generated in the cutting task to have a long product's life. Furthermore, the yield rate will increase accordingly.

It is noted that the present invention may be applied to a mini cutting bite with single spiral portion or spiral portions more than three. Besides, the spiral portion may be provided with two or more chip breaking flutes.

It must be pointed out that the embodiments described above are only some preferred embodiments of the present invention. All equivalent structures which employ the concepts disclosed in this specification and the appended claims should fall within the scope of the present invention.

What is claimed is:

1. A mini cutting bit, comprising:
a shank; and
a cutting part, which is connected to an end of the shank, having a first spiral portion, a first chip removal flute and a first chip breaking flute, wherein the first chip removal flute is parallel to the first spiral portion; the first chip breaking flute is formed on a top of the first spiral portion, and a width of the first chip breaking flute is smaller than that of the top of the first spiral portion.

2. The mini cutting bit of claim 1, wherein the cutting part further has a second spiral portion, a second chip removal flute and a second chip breaking flute; the second spiral portion is parallel to the first spiral portion; the first and the second chip removal flutes are formed between the first and the second spiral portions respectively; the second chip breaking flute is formed on a top of the second spiral portion, and a width of the second chip breaking flute is smaller than that of the top of the second spiral portion.

3. The mini cutting bit of claim 1, wherein the cutting part has a first end and a second end; the second end is connected to the shank, and the first end is opposite to the second end and is a free end; the first chip breaking flute extends between the first end and the second end.

4. The mini cutting bit of claim 1, wherein the first chip breaking flute has two side edges, and the top of the first spiral portion has two side edges; the side edges of the top of the first spiral portion are kept a first distance from the side edges of the first chip breaking flute.

5. The mini cutting bit of claim 2, wherein the cutting part has a first end and a second end; the second end is connected to the shank, and the first end is opposite to the second end and is a free end; the second chip breaking flute extends between the first end and the second end.

6. The mini cutting bit of claim 2, wherein the second chip breaking flute has two side edges, and the top of the second spiral portion has two side edges; the side edges of the top of the second spiral portion are kept a second distance from the side edges of the second chip breaking flute.

7. The mini cutting bit of claim 1, wherein the first chip breaking flute is a V-shaped flute.

8. The mini cutting bit of claim 1, wherein the first chip breaking flute is a U-shaped flute.
